(19) United States
(12) Patent Application Publication
(10) Pub. No.: US 2014/0092004 A1
(43) Pub. Date: Apr. 3, 2014

(54) AUDIO INFORMATION AND/OR CONTROL VIA AN INTERMEDIARY DEVICE

(71) Applicants: ASHOK K. MISHRA, Portland, OR (US); GYAN PRAKASH, Beaverton, OR (US); DUNCAN GLENDINNING, Chandler, AZ (US)

(72) Inventors: ASHOK K. MISHRA, Portland, OR (US); GYAN PRAKASH, Beaverton, OR (US); DUNCAN GLENDINNING, Chandler, AZ (US)

(21) Appl. No.: 13/630,938

(22) Filed: Sep. 28, 2012

(51) Int. Cl. G09G 5/00

(52) U.S. Cl. 345/156

(57) ABSTRACT

The present disclosure is directed to systems and methods related audio information and/or control via intermediary device. For example, a system may comprise a monitor, a peripheral device and a mobile device. The monitor may be configured to present multimedia information based on remote control information received in the monitor over, for example, a wired or wireless HDMI connection. Remote control information may include commands for controlling operation of the monitor when presenting the multimedia information. The peripheral device may be configured to reproduce sound associated with the multimedia information based on audio information received via, for example, wireless communication such as Bluetooth or WLAN. The mobile device may be configured to provide the remote control information to the monitor (e.g., via the wired or wireless HDMI connection) and to provide the audio information to the peripheral device (e.g., via the Bluetooth or WLAN wireless communication).

### TECHNICAL FIELD

The present disclosure relates to communication systems, and more particularly, to systems configured to introduce remote audio and possibly control features to remote devices.

### BACKGROUND

Mobile devices continue to offer new features that help to expand their usability in the marketplace. For example, further to providing simple voice communication, emerging mobile devices may also provide wireless data support for various applications. For example, “smart” phones may include applications configured to support user interactivity, productivity, location awareness, Internet-connectivity, entertainment, electronic commerce, etc. These applications allow users to communicate with other users, manage their day, conduct business, navigate to desired locations, locate items for purchase, play games, etc. all from the palm of their hand. Moreover, wireless communication may also be conducted over extremely short distances for use in, for example, coupling peripheral devices to the mobile device. Peripheral devices such as, for example, headphones, headsets, keyboards, data storage devices, etc. may help enhance user experience when using a mobile device by making it much more usable for various tasks.

The ability to control other devices using a mobile device is a category of functionality that is still rather new but starting to appear in the marketplace. However, this functionality is currently limited to two categories: Internet-driven remote control and component-facilitated remote control. In Internet-driven remote control, application-based and/or Internet-browsing features may be employed to access a web-driven user interface. Manipulating the user interface causes control information to be transmitted to the other device. At least one limitation in these systems is that both devices require Internet connectivity. Component-facilitated remote control may add functionality to a device through external components such as, for example, an infrared transceiver. While Internet connectivity is unnecessary, dedicated equipment must be purchased, coupled to the device, configured, powered by the device, stored/carried when not in use, etc. In addition, these control techniques are limited to simply conveying commands to another device.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example system for audio information and/or control via an intermediary device in accordance with at least one embodiment of the present disclosure;

FIG. 2 illustrates example configurations for a monitor, mobile device and peripheral device in accordance with at least one embodiment of the present disclosure;

FIG. 3 illustrates an example configuration for a peripheral interface module in accordance with at least one embodiment of the present disclosure;

FIG. 4 illustrates example software architecture in accordance with at least one embodiment of the present disclosure; and

FIG. 5 illustrates a flowchart of example operations for audio information and/or control via an intermediary device in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

This disclosure describes systems and methods related audio information and/or control via intermediary device. Initially, wired communication technology such as, for example, high-definition multimedia interface (HDMI) connectivity and wireless communication technologies such as, for example, Bluetooth, wireless local area networking (WLAN) and wireless HDMI may be employed herein merely for the sake of example, and are not intended to be limit any of the disclosed embodiments. On the contrary, embodiments consistent with the present disclosure may be implemented using other wired or wireless communication technologies, existing now or in the future, with similar operational characteristics to the various examples mentioned herein.

In one embodiment, a system may comprise, for example, at least a monitor, a peripheral device and a mobile device. The monitor may be configured to present multimedia information (e.g., display video and/or reproduce sound) based on remote control information received in the monitor over, for example, a wired or wireless HDMI connection. Remote control information may include commands for controlling operation of the monitor when presenting the multimedia information (e.g., input selection, channel selection, volume level, picture configuration, closed-captioning, etc.). The peripheral device may be configured to reproduce sound associated with the multimedia information based on audio information received via, for example, wireless communication such as Bluetooth or WLAN. The mobile device may be configured to provide the remote control information to the monitor (e.g., via the wired or wireless HDMI connection) and to provide the audio information to the peripheral device (e.g., via the Bluetooth or WLAN wireless communication).

In an example embodiment where wired or wireless HDMI connects the monitor and the mobile device and wireless Bluetooth or WLAN communication couples the mobile device to the peripheral device, the mobile device may be configured to receive audio information from the monitor over the HDMI connection and to provide the audio information to the peripheral device via wireless communication. If necessary, the mobile device may also format the audio information received from the monitor for conveyance over Bluetooth prior to transmission. In one embodiment, the peripheral device may be further configured to capture voice command information spoken by a user. The peripheral device may be configured to provide the voice command information to the mobile device, which may be configured to convert the voice command information into remote control information prior to providing it to the monitor.

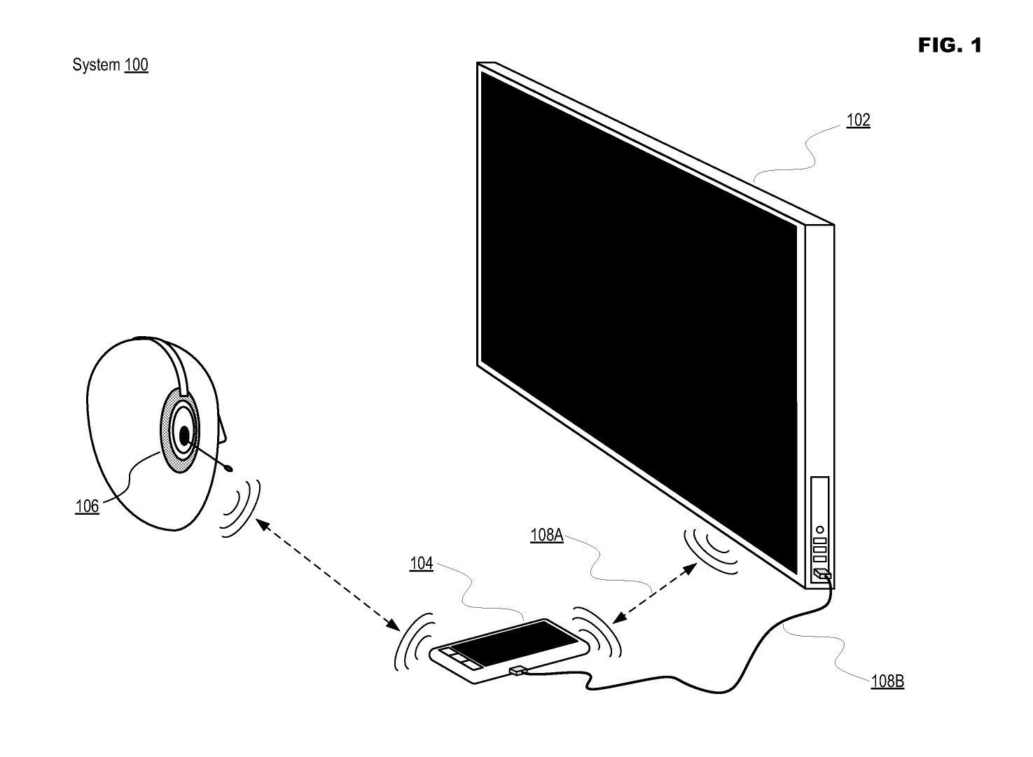

FIG. 1 illustrates an example system for audio information and/or control via an intermediary device (hereafter, “system 100”) in accordance with at least one embodiment of the present disclosure. System 100 may comprise, for example, monitor 102, mobile device 104 and peripheral device 106. Monitor 102 may include devices able to present multimedia information such as, for example, televisions, computer displays, projection systems, etc. Monitor 102 may be based on various display technologies such as, for example, cathode ray tube (CRT), liquid crystal (LCD), plasma, light emitting diode (LED), active-matrix organic LED (AMOLED), etc. The display and control features for monitor 102 may be integrated such as, for example, in a television or may be situated in separate components (e.g., a computer with an external monitor).

Examples of mobile device 104 may include, but are not limited to, a mobile communication device such as a cellular handset or a smartphonebased on the Android® operating system (OS), iOS®, Blackberry® OS, Palm® OS, Symbian® OS, etc., a mobile computing device such as a tablet computer like an iPad®, Galaxy Tab, Kindle Fire®, etc., an Ultrabook® including a low-power chipset manufactured by Intel Corp., a netbook, a notebook computer, a laptop computer, etc. Mobile device 104 may be configured to communicate with monitor 102 via wireless communication 108A or wired communication 108B. For example, an HDMI connection may be established using a cable or through the use of wireless transceiver equipment. While not required, employing HDMI in example implementations consistent with the present disclosure may be advantageous in that HDMI (e.g., wired HDMI versions 1.4 and after) has incorporated useful features. Initially, the Audio Return Channel (ARC) allows digital audio to be transmitted and received over HDMI, removing the requirement for separate audio cables to convey sound associated with HDMI video between components (e.g., between a television, stereo equipment, media players and recorders, television tuner equipment, etc.). Moreover, Consumer Electronic Control (CEC) allows various HDMI-connected devices to be controlled through a wireless remote link to only one of the devices. For example, commands associated with a particular device may be conveyed wirelessly to any HDMI-connected device, and the commands will then be applied to the particular device targeted by the command over a bidirectional serial bus that couples all of the HDMI connected devices.

The choice of wired communication 108B vs. wireless communication 108A may depend on the particular features needed or desired for an application. Wired HDMI ports have already been incorporated into many televisions and computer systems, and are becoming more common in mobile devices, making the cost of implementation very reasonable (e.g., the only additional equipment that may be necessary is an HDMI cable). In one example configuration consistent with the present disclosure, a wired HDMI port may be incorporated into a dock (not pictured) for mobile device 104, allowing mobile device 104 to be recharged and while simultaneously performing communication-related functionality. Alternatively, employing a wireless HDMI connection may allow monitor 102 and mobile device 104 to be located further apart, possibly without a need for any additional equipment if the both of the devices include wireless HDMI transceivers. However, drawbacks that may exist for any wireless system may include battery consumption concerns due to transceiver use, vulnerability to interference, slower speeds, etc.

Peripheral device 106 may be any device capable of reproducing sound based on audio information received from an external source. For example, peripheral device 106 may receive audio information from mobile device 104 via wireless communication (e.g., Bluetooth, WLAN, etc.). While peripheral device 106 is illustrated in FIG. 1 as a wireless headset, other examples of peripheral apparatus 106 may also include, but are not limited to a wireless receiver connected by wire to a headset or speakers, a wireless speaker system, etc. In one embodiment peripheral apparatus 106 may include a sound recording device (e.g., a microphone) configured to capture voice commands issued by a user for controlling monitor 102 (e.g., hereafter voice command information). Peripheral device 106 may be configured to provide the captured voice command information to mobile device 104 via wireless communication.

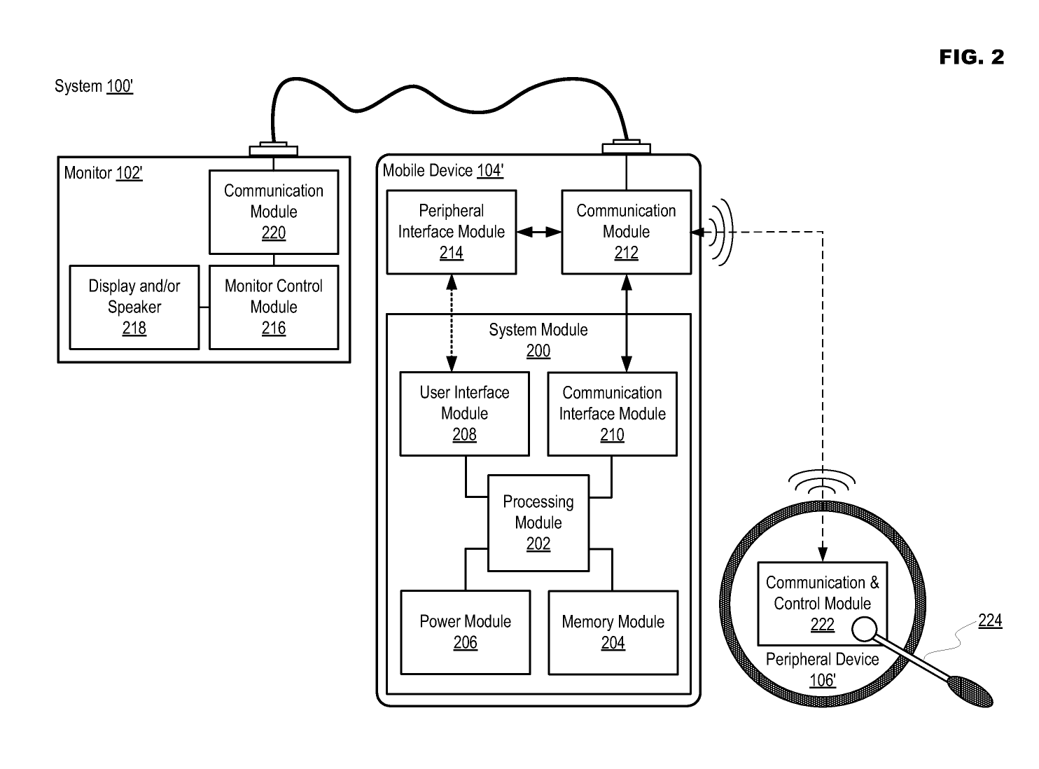

FIG. 2 illustrates example configurations for monitor 102′, mobile device 104′ and peripheral device 106′ in accordance with at least one embodiment of the present disclosure. Mobile device 104′ may comprise, for example, system module 200, which may be configured to manage normal operations in mobile device 104′. System module 200 may comprise, for example, processing module 202, memory module 204, power module 206, user interface module 208 and communication interface module 210, which may be configured to interact with communication module 212. Further, peripheral interface module 214 may be configured to interact with at least communication module 212 and possibly user interface module 214. While communication module 212 and peripheral interface module 214 are shown separately from system module 200, the illustrated configuration is merely for the sake of explanation herein. Some or all of the functionality associated with modules 212 and 214 may also be included in system module 200. Monitor 102′ may comprise, for example, monitor control module 216, display and/or speaker 218 and monitor communication module 220. Peripheral device 106′ may comprise, for example, communication & control module 222, a speaker (not visible from the perspective shown in FIG. 2) and microphone 224. While communication & control module 222 has been shown as one module, a communication module separate from a control module may also exist depending on, for example, the size of peripheral device 106′.

In mobile device 104′, processing module 202 may comprise one or more processors situated in separate components, or alternatively, may comprise one or more processing cores embodied in a single component (e.g., in a System-on-a-Chip (SOC) configuration) and any processor-related support circuitry (e.g., bridging interfaces, etc.). Example processors may include various x86-based microprocessors available from the Intel Corporation including those in the Pentium, Xeon, Itanium, Celeron, Atom, Core i-series product families. Examples of support circuitry may include chipsets (e.g., Northbridge, Southbridge, etc. available from the Intel Corporation) configured to provide an interface through which processing module 202 may interact with other system components that may be operating at different speeds, on different buses, etc. in mobile device 104′. Some or all of the functionality commonly associated with the support circuitry may also be included in the same physical package as the processor (e.g., an SOC package like the Sandy Bridge integrated circuit available from the Intel Corporation).

Processing module 202 may be configured to execute instructions in mobile device 104′. Instructions may include program code configured to cause processing module 202 to perform activities related to reading data, writing data, processing data, formulating data, converting data, transforming data, etc. Information (e.g., instructions, data, etc.) may be stored in memory module 204. Memory module 204 may comprise random access memory (RAM) or read-only memory (ROM) in a fixed or removable format. RAM may include memory configured to hold information during the operation of signage controller 106′ such as, for example, static RAM (SRAM) or Dynamic RAM (DRAM). ROM may include memories such as bios memory configured to provide instructions when mobile device 104′ activates, programmable memories such as electronic programmable ROMs (EPROMS), Flash, etc. Other fixed and/or removable memory may include magnetic memories such as, for example, floppy disks, hard drives, etc., electronic memories such as solid state flash memory (e.g., embedded multimedia card (eMMC), etc.), removable memory cards or sticks (e.g., micro storage device (uSD), USB, etc.), optical memories such as compact disc-based ROM (CD-ROM), etc. Power module 206 may include internal power sources (e.g., a battery) and/or external power sources (e.g., electromechanical or solar generator, power grid, etc.), and related circuitry configured to supply mobile device 104′ with the power needed to operate.

User interface module 208 may include circuitry configured to allow users to interact with mobile device 104′ such as, for example, various input mechanisms (e.g., microphones, switches, buttons, knobs, keyboards, speakers, touch-sensitive surfaces, one or more sensors configured to capture images and/or sense proximity, distance, motion, gestures, etc.) and output mechanisms (e.g., speakers, displays, lighted/flashing indicators, electromechanical components for vibration, motion, etc.). Communication interface module 210 may be configured to handle packet routing and other control functions for communication module 212, which may include resources configured to support wired and/or wireless communications. Wired communications may include serial and parallel wired mediums such as, for example, Ethernet, Universal Serial Bus (USB), Firewire, Digital Visual Interface (DVI), HDMI, etc. Wireless communications may include, for example, close-proximity wireless mediums (e.g., radio frequency (RF) such as based on the Near Field Communications (NFC) standard, infrared (IR), optical character recognition (OCR), magnetic character sensing, etc.), short-range wireless mediums (e.g., Bluetooth, WLAN, Wi-Fi, etc.) and long range wireless mediums (e.g., cellular, satellite, etc.). In one embodiment, communication interface module 210 may be configured to prevent wireless communications that are active in communication module 212 from interfering with each other. In performing this function, communication interface module 210 may schedule activities for communication module 212 based on, for example, the relative priority of messages awaiting transmission.

Peripheral interface module 214 may be configured to utilize communication module 212 for managing interactions between mobile device 104′ and monitor 102′, as well as interactions between mobile device 104′ and peripheral device 106′. Peripheral interface module 214 may, for example, transmit remote control information (e.g., commands) to monitor communication module 220 via communication module 212. While the connection between mobile device 104′ and monitor 102′ is shown in FIG. 2 as a wired connection, it is also possible for this connection to be wireless. Monitor communication module 220 may receive the remote control information and may pass the remote control information to monitor control module 216 for processing. In the instance where the connection between mobile device 104′ and monitor 102′ is an HDMI connection, the remote control information may be CEC information. Monitor control module 220 may include processing and/or memory resources configured to control the display and/or speaker in monitor 102′ based on the remote control instructions. For example, the remote control instructions may configure the input for multimedia information presented on monitor 102′, may cause the channel to change, may cause the volume to change, may change the picture configuration or other setup characteristic of monitor 102′, etc. Based on the abilities of CEC, it is also possible for the remote control instructions to control the operation of other equipment coupled to monitor 102′ via HDMI such as, for example, stereo equipment, media players and recorders, television tuner equipment, etc. In one embodiment, peripheral interface module 214 may be configured to cause communication module 212 to transmit remote control information causing monitor 102′ to enter a configuration for transmitting audio information. For example, monitor 102′ may mute local sound generation (e.g., in monitor 102′ or coupled to it via HDMI) and may then transmit audio information to mobile device 104′ (e.g., via the HDMI connection).

Peripheral interface module 214 may also be configured to interact with communication & control module 222 in peripheral device 106′ via communication module 212. For example, peripheral interface module may be configured to receive the audio information from monitor 102′ (e.g., via the HDMI connection) and may cause communication module 212 to transmit the audio information to communication & control module 222 for sound reproduction in peripheral device 106′. In some instances, such as, for example, when the audio information is received via an HDMI connection and is to be transmitted via Bluetooth or WLAN wireless communication, peripheral interface module 214 may convert the audio information prior to transmission. For example, the audio received via HDMI will be, at a minimum, stereo uncompressed pulse code modulation (PCM) and possibly even lossless compressed audio in Dolby True High Definition (HD) and digital theater system-high definition (DTS-HD). These formats may be converted into information that is transmittable via wireless communication (e.g., Bluetooth or WLAN).

Peripheral interface module may also receive and process voice command information received from peripheral device 106′. For example, communication & control module 222 may be configured to utilize microphone 222 in capturing voice commands issued by a user (e.g., wearing peripheral device 106′). Voice commands may be predefined phrases designed to control certain features of monitor 102′ such as, for example, “power on/off”, “select <input>”, “channel up/down”, “volume up/down”, “play <media>”, etc. Commands may also be directed to functionality on mobile device 104′ including, for example, connecting/disconnecting mobile device 104′ to monitor 102′ (“connect/disconnect <device>”), answering an incoming call (e.g., “answer call”), etc. Voice command information may be transmitted by communication & control module 222 to peripheral interface module 214 via communication module 212. Once received in peripheral interface module 214, the voice command information may be converted into remote control information. In one embodiment, the voice command information may first be converted from voice to text, and the text may be converted to a remote control command. The remote control information may then be transmitted to monitor 102′ (e.g., via HDMI). In one embodiment, peripheral interface module 214 may be configured to interact with user interface module 208 to cause a confirmation of a received command to be displayed on mobile device 208, to cause a confirmation tone to be played by mobile device 104′, etc. Alternatively, a confirmation may also be displayed on monitor 102′ such as, for example, the identification of a received command in text, as an indicator/icon, a tone to be played by monitor 102′, etc.

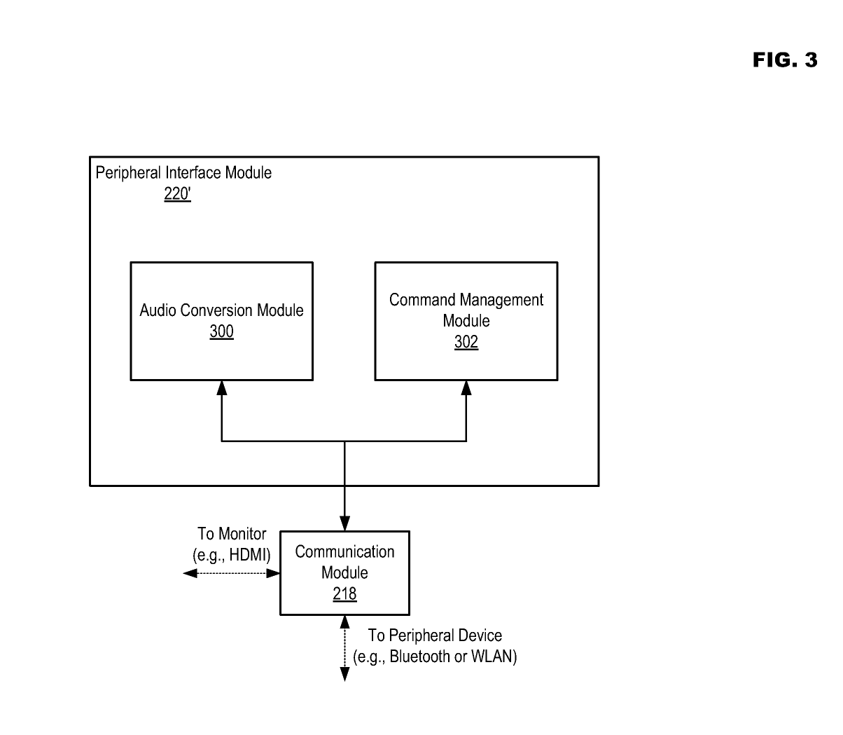

FIG. 3 illustrates an example configuration for peripheral interface module 220′ in accordance with at least one embodiment of the present disclosure. Peripheral interface module 220′ may comprise, for example, audio conversion module 300 and command management module 302. Audio conversion module 300 may be configured to manage audio information flowing from monitor 102 to peripheral device 106 via mobile device 104. Management of the audio information may include formatting the audio information received via a communication medium connecting monitor 102 to mobile device 104 (e.g., HDMI) for transmission on another communication medium connecting mobile device 104 to peripheral device 106 (e.g., Bluetooth or WLAN) such as described above. Command management module 302 may be configured to manage voice command information flowing from peripheral device 106 to monitor 102 via mobile device 104. Management of the voice command information may include conversion of the voice command information to remote control information such as described above.

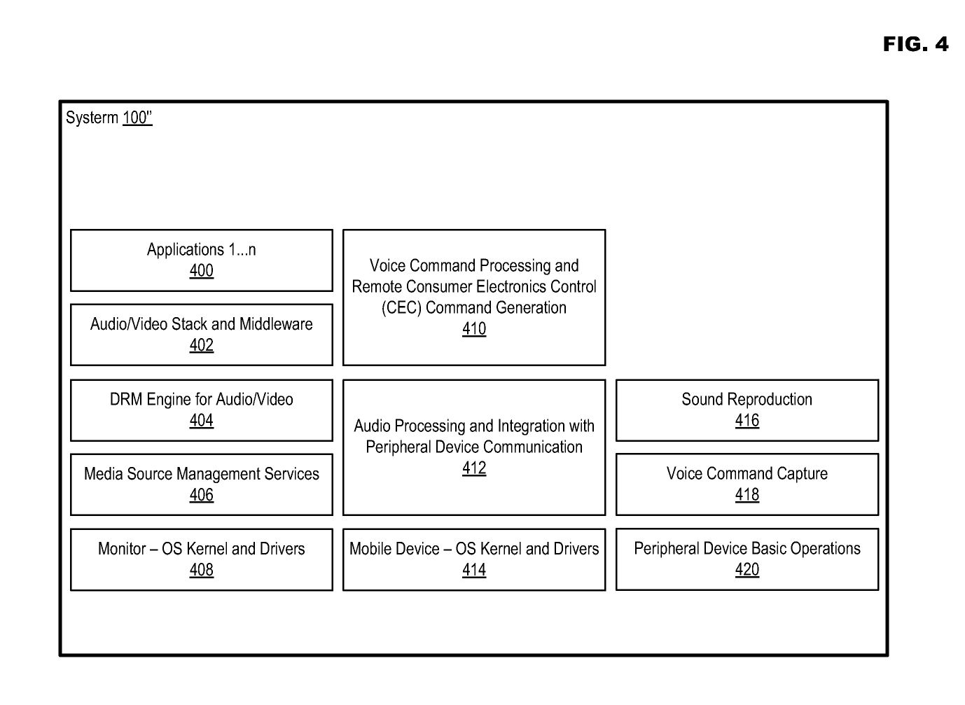

FIG. 4 illustrates example software architecture in accordance with at least one embodiment of the present disclosure. System 100″ may include operational stacks comprising multiple layers corresponding to monitor 102 (layers 400-408), to mobile device 104 (layers 410 to 414) and peripheral device 106 (layers 416 to 420). While the layers in FIG. 4 are presented in a particular order, the illustrated order is not intended to be limiting and may vary somewhat depending on how system 100″ is actually implemented. For example, topmost layer 400 may include applications 1 . . . n corresponding to functionality in monitor 102. Applications 1 . . . n may correspond to media storage/playback operations, communication-related operations, Internet-related operations, etc. Layer 102 may correspond to audio/video stack and middleware that may be configured to control the general operation of monitor 102 (e.g., during the presentation of multimedia information). Layer 404 may comprise Digital Rights Management (DRM) features for audio and/or video to be presented on monitor 102. For example, layer 404 may authenticate the validity (e.g., licensing) for multimedia content to be displayed on monitor 102. Layer 406 may include media source manage services configured to obtain multimedia information to present on display 102. The media sources to be managed may include local storage equipment and/or remote sources (e.g., cloud and/or other internet-based sources). Layer 408 may correspond to the operating system (OS) kernel and drivers needed for operating monitor 102.

Layers 410 to 414 may exist in mobile device 104. Topmost layer 410 may include voice command processing and remote CEC command processing resources. For example, layer 410 may be configured to receive voice command information (e.g., from peripheral device 106) and to convert the voice command information into remote control information. Layer 412 may then correspond to audio processing and integration with peripheral device 106 communication. For example, layer 412 may be configured to receive audio information from monitor 102 (e.g. via wired or wireless HDMI), to format the audio information for transmission to peripheral device 106 (e.g., via Bluetooth or WLAN), and to then transmit the audio information. Layer 414 may include, for example, an OS kernel and drivers needed for operating mobile device 104.

Layers 416 to 420 may exist in peripheral device 106. Layer 416 may correspond to sound reproduction functionality including, for example, resources for reproducing sound based on audio information received from mobile device 104. Layer 418 may include voice command capture functionality. For example, layer 418 may be configured to cause microphone 224 in peripheral device 106 to capture voice command information from a user, and to transmit the captured voice command information to mobile device 104. Layer 420 may be configured to handle basic operations for peripheral device 106. Layer 420 may include, for example, an OS kernel and drivers similar to monitor 102 and mobile device 104, or alternatively, may contain a much simpler control system if peripheral device 106 does not arise to that level of complexity.

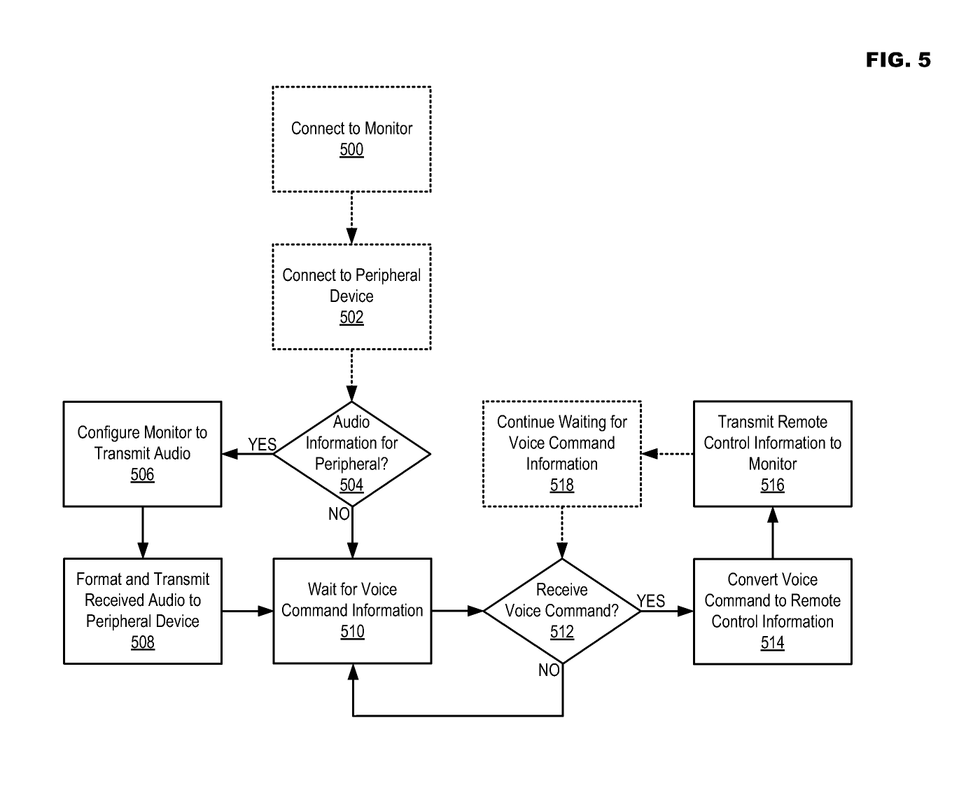

FIG. 5 illustrates a flowchart of example operations for audio information and/or control via an intermediary device in accordance with at least one embodiment of the present disclosure. The example operations illustrated in FIG. 5 are from the viewpoint of a mobile device. Initially, connections may be established to a monitor (e.g., via a wired or wireless HDMI connection) and to a peripheral device (e.g., via a Bluetooth or WLAN wireless connection) in operations 500 and 502, respectively. Operations 500 and 502 have been indicated as optional (e.g., dotted border) because it is also possible to perform the example operations illustrated in FIG. 5 when already coupled to the monitor and the peripheral device. In operation 504 a determination may be made as to whether audio information is required at the peripheral device. The determination may be based on, for example, an automatic configuration (e.g., triggered by connecting to the monitor) or a manual configuration made in the monitor, the mobile device or the peripheral device. If it determined in operation 504 that audio is required at the peripheral device, then in operation 506 the monitor may be configured to transmit the audio information. For example, a command may be transmitted to the monitor instructing that local sound reproduction should stop (e.g., muted) and that audio information corresponding to multimedia information presented on the monitor should be transmitted to the mobile device. The audio information received from the monitor may then be formatted and transmitted to the peripheral device in operation 508.

If a determination is made in operation 504 that audio information is not required in the peripheral device, or alternatively after operation 508, then in operation 510 the mobile device may then wait for the receipt of voice command information (e.g., from the peripheral device). A determination may then be made in operation 512 as to whether voice command information has been received. If a determination is made in operation 512 that voice command information has been received, then in operation 514 the voice command information may be converted to remote control information. For example, the voice command information may be converted from captured sound information to textual information, and then the textual information may then be converted into one or more remote control commands (e.g., one or more CEC commands in instances where an HDMI connection is being employed). The remote control information may then be transmitted to the monitor in operation 516. In one embodiment, the mobile device may continue waiting for voice command information in optional operation 518 and may return to operation 512 to determine whether additional voice command information has been received.

While FIG. 5 illustrates various operations according to an embodiment, it is to be understood that not all of the operations depicted in FIG. 5 are necessary for other embodiments. Indeed, it is fully contemplated herein that in other embodiments of the present disclosure, the operations depicted in FIG. 5, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, the present disclosure is directed to systems and methods related audio information and/or control via intermediary device. An example system may comprise a monitor, a peripheral device and a mobile device. The monitor may be configured to present multimedia information based on remote control information received in the monitor over, for example, a wired or wireless HDMI connection. Remote control information may include commands for controlling operation of the monitor when presenting the multimedia information. The peripheral device may be configured to reproduce sound associated with the multimedia information based on audio information received via, for example, wireless communication such as Bluetooth or WLAN. The mobile device may be configured to provide the remote control information to the monitor (e.g., via the wired or wireless HDMI connection) and to provide the audio information to the peripheral device (e.g., via the Bluetooth or WLAN wireless communication).

The following examples pertain to further embodiments. In one example embodiment there is provided a device. The device may include a communication module configured to receive and transmit at least audio information and remote control information, and a peripheral interface module configured to interact with the communication module to receive the audio information from a monitor, to provide the audio information to a peripheral device, to receive the remote control information from the peripheral device, and to provide the remote control information to the monitor.

The above example device may be further configured, wherein the communication module is further configured to receive the audio information from the monitor, and to provide the remote control information to the monitor, via a wired or wireless High-Definition Multimedia Interface (HDMI) connection. In this configuration the example device may be further configured, wherein the remote control information provided to the monitor includes Consumer Electronics Control (CEC) commands conveyed over HDMI. In this configuration the example device may be further configured, wherein the remote control information received from the peripheral device comprises voice command information, the peripheral interface module being further configured to convert the voice command information into CEC commands for provision to the monitor.

The above example device may be further configured, alone or in addition to the above further example configurations, wherein the communication module is further configured to provide the audio information to the peripheral device and to receive the remote control information from the peripheral device via at least one of Bluetooth communication or wireless local area networking (WLAN) communication. In this configuration the example device may be further configured, wherein the peripheral interface module is further configured to format the audio information for conveyance over at least one of Bluetooth or WLAN communication prior to providing the audio information to the peripheral device.

In another example embodiment there is provided a device. The device may include a display configured to present multimedia content, a communication module configured to receive and transmit at least audio information corresponding to the multimedia content and remote control information, and a monitor control module configured to interact with the communication module to transmit the audio information to a mobile device and to receive remote control commands from the mobile device.

The above example device may be further configured, wherein the monitor control module is further configured to control the presentation of the multimedia content based on the received remote control information.

The above example device may be further configured, alone or in addition to the above further example configurations, wherein the communication module is further configured to provide the audio information to the mobile device, and to receive the remote control information from the mobile device, via a wired or wireless High-Definition Multimedia Interface (HDMI) connection. In this configuration the example device may be further configured, wherein the remote control information includes Consumer Electronics Control (CEC) commands conveyed over HDMI.

In another example embodiment there is provided a method. The method may include determining to provide audio information to a peripheral device, configuring a monitor to provide the audio information, receiving the audio information from the monitor, and transmitting the received audio information to the peripheral device.

The above example method may be further configured, wherein configuring the monitor comprises transmitting remote control information to the monitor, the remote control information instructing the monitor to provide the audio information. In this configuration the example method may be further configured, wherein the remote control information is transmitted to the monitor via a wired or wireless High-Definition Multimedia Interface (HDMI) connection. In this configuration the example method may be further configured, wherein the remote control information includes Consumer Electronics Control (CEC) commands conveyed over HDMI.

The above example method may further comprise, alone or in addition to the above further example configurations, formatting the received audio information for conveyance over wireless communication before transmitting the received audio information. In this configuration the example method may be further configured, wherein wireless communication includes at least one of Bluetooth communication or wireless local area networking (WLAN) communication.

The above example method may further comprise, alone or in addition to the above further example configurations, receiving voice command information from the peripheral device. In this configuration the example method may further comprise converting the voice command information into remote control information and transmitting the remote control information to the monitor.

In another example embodiment there is provided a method. The method may include receiving remote control information from a mobile device over a High-Definition Multimedia Interface (HDMI) connection, and providing audio information to the mobile device over the High-Definition Multimedia Interface (HDMI) connection based on the remote control information.

The above example method may further comprise presenting multimedia information, the audio information corresponding to the multimedia information. In this configuration, the example method may further comprise controlling the presentation of the multimedia information based on the received remote control information.

In another example embodiment there is provided a system including at least a monitor, a mobile device and a peripheral device, the system being arranged to perform any of the above example methods.

In another example embodiment there is provided a mobile device chipset arranged to perform any of the above example methods as they may pertain to a mobile device.

In another example embodiment there is provided a monitor chipset arranged to perform any of the above example methods as they may pertain to a monitor.

In another example embodiment there is provided at least one machine readable medium comprising a plurality of instructions that, in response to be being executed on a computing device, cause the computing device to carry out any of the above example methods.

In another example embodiment there is provided a mobile device arranged to perform any of the above example methods as they may pertain to a mobile device.

In another example embodiment there is provided a monitor arranged to perform any of the above example methods as they may pertain to a monitor.

In another example embodiment there is provided a mobile device having means to perform any of the above example methods as they may pertain to a mobile device.

In another example embodiment there is provided a monitor having means to perform any of the above example methods as they may pertain to a monitor.

In another example embodiment there is provided a device. The device may include a communication module configured to receive and transmit at least audio information and remote control information, and a peripheral interface module configured to interact with the communication module to receive the audio information from a monitor, to provide the audio information to a peripheral device, to receive the remote control information from the peripheral device, and to provide the remote control information to the monitor.

The above example device may be further configured, wherein the communication module is further configured to receive the audio information from the monitor, and to provide the remote control information to the monitor, via a wired or wireless High-Definition Multimedia Interface (HDMI) connection, and further wherein the remote control information provided to the monitor includes Consumer Electronics Control (CEC) commands conveyed over HDMI. In this configuration the example device may be further configured, wherein the remote control information received from the peripheral device comprises voice command information, the peripheral interface module being further configured to convert the voice command information into CEC commands for provision to the monitor.

The above example device may be further configured, alone or in addition to the above further example configurations, wherein the communication module is further configured to provide the audio information to the peripheral device and to receive the remote control information from the peripheral device via at least one of Bluetooth communication or wireless local area networking (WLAN) communication, the peripheral interface module being further configured to format the audio information for conveyance over at least one of Bluetooth or WLAN communication prior to providing the audio information to the peripheral device.

In another example embodiment there is provided a device. The device may include a display configured to present multimedia content, a communication module configured to receive and transmit at least audio information corresponding to the multimedia content and remote control information, and a monitor control module configured to interact with the communication module to transmit the audio information to a mobile device and to receive remote control commands from the mobile device.

The above example device may be further configured, wherein the monitor control module is further configured to control the presentation of the multimedia content based on the received remote control information.

The above example device may be further configured, alone or in addition to the above further example configurations, wherein the communication module is further configured to provide the audio information to the mobile device, and to receive the remote control information from the mobile device, via a wired or wireless High-Definition Multimedia Interface (HDMI) connection, and further wherein the remote control information includes Consumer Electronics Control (CEC) commands conveyed over HDMI.

In another example embodiment there is provided a method. The method may include determining to provide audio information to a peripheral device, configuring a monitor to provide the audio information, receiving the audio information from the monitor, and transmitting the received audio information to the peripheral device.

The above example method may be further configured, wherein configuring the monitor comprises transmitting remote control information to the monitor via a wired or wireless High-Definition Multimedia Interface (HDMI) connection, the remote control information including Consumer Electronics Control (CEC) commands instructing the monitor to provide the audio information.

The above example method may further comprise, alone or in addition to the above further example configurations, formatting the received audio information for conveyance over includes at least one of Bluetooth communication or wireless local area networking (WLAN) communication before transmitting the received audio information.

The above example method may further comprise, alone or in addition to the above further example configurations, receiving voice command information from the peripheral device and converting the voice command information into remote control information and transmitting the remote control information to the monitor.

In another example embodiment there is provided a method. The method may include receiving remote control information from a mobile device over a High-Definition Multimedia Interface (HDMI) connection, and providing audio information to the mobile device over the High-Definition Multimedia Interface (HDMI) connection based on the remote control information.

The above example method may further comprise presenting multimedia information, the audio information corresponding to the multimedia information, and controlling the presentation of the multimedia information based on the received remote control information.

In another example embodiment there is provided at least one of a mobile device chipset or a monitor chipset arranged to perform any of the above example methods.

In another example embodiment there is provided at least one machine readable medium comprising a plurality of instructions that, in response to be being executed on a computing device, cause the computing device to carry out any of the above example methods.

In one example embodiment there is provided a device. The device may comprise a communication module configured to receive and transmit at least audio information and remote control information, and a peripheral interface module configured to interact with the communication module to receive the audio information from a monitor, to provide the audio information to a peripheral device, to receive the remote control information from the peripheral device, and to provide the remote control information to the monitor. The above example device may be further configured, wherein the communication module is further configured to receive the audio information from the monitor, and to provide the remote control information to the monitor, via a wired or wireless High-Definition Multimedia Interface (HDMI) connection. In this configuration the example device may be further configured, wherein the remote control information provided to the monitor includes Consumer Electronics Control (CEC) commands conveyed over HDMI. In this configuration the example device may be further configured, wherein the remote control information received from the peripheral device comprises voice command information, the peripheral interface module being further configured to convert the voice command information into CEC commands for provision to the monitor.

The above example device may be further configured, alone or in addition to the above further example configurations, wherein the communication module is further configured to provide the audio information to the peripheral device and to receive the remote control information from the peripheral device via at least one of Bluetooth communication or wireless local area networking (WLAN) communication. In this configuration the example device may be further configured, wherein the peripheral interface module is further configured to format the audio information for conveyance over at least one of Bluetooth or WLAN communication prior to providing the audio information to the peripheral device.

In another example embodiment there is provided a device. The device may include a display configured to present multimedia content, a communication module configured to receive and transmit at least audio information corresponding to the multimedia content and remote control information, and a monitor control module configured to interact with the communication module to transmit the audio information to a mobile device and to receive remote control commands from the mobile device.

The above example device may be further configured, wherein the monitor control module is further configured to control the presentation of the multimedia content based on the received remote control information.

The above example device may be further configured, alone or in addition to the above further example configurations, wherein the communication module is further configured to provide the audio information to the mobile device, and to receive the remote control information from the mobile device, via a wired or wireless High-Definition Multimedia Interface (HDMI) connection. In this configuration the example device may be further configured, wherein the remote control information includes Consumer Electronics Control (CEC) commands conveyed over HDMI.

In another example embodiment there is provided a method. The method may include determining to provide audio information to a peripheral device, configuring a monitor to provide the audio information, receiving the audio information from the monitor, and transmitting the received audio information to the peripheral device.

The above example method may be further configured, wherein configuring the monitor comprises transmitting remote control information to the monitor, the remote control information instructing the monitor to provide the audio information. In this configuration the example method may be further configured, wherein the remote control information is transmitted to the monitor via a wired or wireless High-Definition Multimedia Interface (HDMI) connection. In this configuration the example method may be further configured, wherein the remote control information includes Consumer Electronics Control (CEC) commands conveyed over HDMI. The above example method may further comprise, alone or in addition to the above further example configurations, formatting the received audio information for conveyance over wireless communication before transmitting the received audio information. In this configuration the example method may be further configured, wherein wireless communication includes at least one of Bluetooth communication or wireless local area networking (WLAN) communication.

The above example method may further comprise, alone or in addition to the above further example configurations, receiving voice command information from the peripheral device. In this configuration the example method may further comprise converting the voice command information into remote control information and transmitting the remote control information to the monitor.

In another example embodiment there is provided a method. The method may include receiving remote control information from a mobile device over a High-Definition Multimedia Interface (HDMI) connection, and providing audio information to the mobile device over the High-Definition Multimedia Interface (HDMI) connection based on the remote control information.

The above example method may further comprise presenting multimedia information, the audio information corresponding to the multimedia information. In this configuration, the example method may further comprise controlling the presentation of the multimedia information based on the received remote control information.

In another example embodiment there is provided a system. The system may include means for determining to provide audio information to a peripheral device, means for configuring a monitor to provide the audio information, mean for receiving the audio information from the monitor, and means for transmitting the received audio information to the peripheral device.

The above example system may be further configured, wherein configuring the monitor comprises transmitting remote control information to the monitor, the remote control information instructing the monitor to provide the audio information. In this configuration the example system may be further configured, wherein the remote control information is transmitted to the monitor via a wired or wireless High-Definition Multimedia Interface (HDMI) connection. In this configuration the example system may be further configured, wherein the remote control information includes Consumer Electronics Control (CEC) commands conveyed over HDMI.

The above example system may further comprise, alone or in addition to the above further example configurations, means for formatting the received audio information for conveyance over wireless communication before transmitting the received audio information. The example system may be further configured, wherein wireless communication includes at least one of Bluetooth communication or wireless local area networking (WLAN) communication.

The above example system may further comprise, alone or in addition to the above further example configurations, means for receiving voice command information from the peripheral device. In this configuration the example system may further comprise means for converting the voice command information into remote control information and transmitting the remote control information to the monitor.

In another example embodiment there is provided a system. The system may include means for receiving remote control information from a mobile device over a High-Definition Multimedia Interface (HDMI) connection, and means for providing audio information to the mobile device over the High-Definition Multimedia Interface (HDMI) connection based on the remote control information.

The above example system may further comprise means for presenting multimedia information, the audio information corresponding to the multimedia information. In this configuration, the example system may further comprise means for controlling the presentation of the multimedia information based on the received remote control information.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. A device, comprising:
a communication module configured to receive and transmit at least audio information and remote control information; and
a peripheral interface module configured to interact with the communication module to receive the audio information from a monitor, to provide the audio information to a peripheral device, to receive the remote control information from the peripheral device, and to provide the remote control information to the monitor.

2. The device of claim 1, wherein the communication module is further configured to receive the audio information from the monitor, and to provide the remote control information to the monitor, via a wired or wireless High-Definition Multimedia Interface (HDMI) connection.

3. The device of claim 2, wherein the remote control information provided to the monitor includes Consumer Electronics Control (CEC) commands conveyed over HDMI.

4. The device of claim 3, wherein the remote control information received from the peripheral device comprises voice command information, the peripheral interface module being further configured to convert the voice command information into CEC commands for provision to the monitor.

5. The device of claim 1, wherein the communication module is further configured to provide the audio information to the peripheral device and to receive the remote control information from the peripheral device via at least one of Bluetooth communication or wireless local area networking (WLAN) communication.

6. The device of claim 5, wherein the peripheral interface module is further configured to format the audio information for conveyance over at least one of Bluetooth or WLAN communication prior to providing the audio information to the peripheral device.

7. A device, comprising:
a display configured to present multimedia content;
a communication module configured to receive and transmit at least audio information corresponding to the multimedia content and remote control information; and
a monitor control module configured to interact with the communication module to transmit the audio information to a mobile device and to receive remote control commands from the mobile device.

8. The device of claim 7, wherein the monitor control module is further configured to control the presentation of the multimedia content based on the received remote control information.

9. The device of claim 7, wherein the communication module is further configured to provide the audio information to the mobile device, and to receive the remote control information from the mobile device, via a wired or wireless High-Definition Multimedia Interface (HDMI) connection.

10. The device of claim 10, wherein the remote control information includes Consumer Electronics Control (CEC) commands conveyed over HDMI.

11. A computer program product comprising at least one machine-readable storage medium having stored thereon, individually or in combination, instructions that when executed by one or more processors result in the following operations comprising:
determining to provide audio information to a peripheral device;
configuring a monitor to provide the audio information;
receiving the audio information from the monitor; and
transmitting the received audio information to the peripheral device.

12. The computer program product of claim 17, wherein configuring the monitor comprises transmitting remote control information to the monitor, the remote control information instructing the monitor to provide the audio information.

13. The computer program product of claim 18, wherein the remote control information is transmitted to the monitor via a wired or wireless High-Definition Multimedia Interface (HDMI) connection.

14. The computer program product of claim 19, wherein the remote control information includes Consumer Electronics Control (CEC) commands conveyed over HDMI.

15. The computer program product of claim 17, further comprising instructions that when executed by one or more processors result in the following operations comprising:
formatting the received audio information for conveyance over wireless communication before transmitting the received audio information.

16. The computer program product of claim 21, wherein wireless communication includes at least one of Bluetooth communication or wireless local area networking (WLAN) communication.

17. The computer program product of claim 17, further comprising instructions that when executed by one or more processors result in the following operations comprising:
receiving voice command information from the peripheral device.

18. The computer program product of claim 23, further comprising instructions that when executed by one or more processors result in the following operations comprising:
converting the voice command information into remote control information; and
transmitting the remote control information to the monitor.

19. A computer program product comprising at least one machine-readable storage medium having stored thereon, individually or in combination, instructions that when executed by one or more processors result in the following operations comprising:
receiving remote control information from a mobile device over a High-Definition Multimedia Interface (HDMI) connection; and
providing audio information to the mobile device over the High-Definition Multimedia Interface (HDMI) connection based on the remote control information.

20. The computer program product of claim 30, further comprising instructions that when executed by one or more processors result in the following operations comprising:
presenting multimedia information, the audio information corresponding to the multimedia information.

21. The computer program product of claim 20, further comprising controlling the presentation of the multimedia information based on the received remote control information.
